(19) United States
(12) Patent Application Publication
(10) Pub. No.: US 2026/0085572 A1
(43) Pub. Date: Mar. 26, 2026

(54) LOCKBOX WITH EXTERNAL CREDENTIAL DETECTION

(71) Applicant: Tyco Fire & Security GmbH, Neuhausen am Rheinfall (CH)

(72) Inventors: Matthew H. PAUL, Palatine, IL (US); Jason M. OUELLETTE, Leominster, MA (US); Chris TRAPANI, Neuhausen am Rheinfall (CH); Brian SEARFOSS, Neuhausen am Rheinfall (CH)

(21) Appl. No.: 19/334,272

(22) Filed: Sep. 19, 2025

Related U.S. Application Data
(60) Provisional application No. 63/698,899, filed on Sep. 25, 2024.

(51) Int. Cl. E05G 1/04; G06V 20/52

(52) U.S. Cl. CPC E05G 1/04; G06V 20/52

(57) ABSTRACT

The present disclosure relates to a lockbox that houses one or more credentials. The lockbox includes a retainer, a sensing element, and a processing circuit. The sensing element is associated with the retainer and is configured to detect one or more parameters of the retainer to generate a sensed data. The processing circuit is communicatively coupled to the sensing element and is configured to receive the sensed data. The processing circuit is configured to generate a notification signal indicative of presence or absence of the credential in the retainer.

### CROSS-REFERENCE TO RELATED APPLICATION

This patent application claims the benefit of U.S. Provisional Application No. 63/698,899, filed on Sep. 25, 2024, titled “LOCKBOX WITH EXTERNAL CREDENTIAL DETECTION. ” The disclosure of the prior application is hereby incorporated by reference in its entirety.

### BACKGROUND

The present disclosure relates generally to security systems. The present disclosure relates to a lockbox configured to store one or more credentials.

Commonly, lockboxes are also referred as a high security vault. A lockbox may be installed at a location and provide access to interior contents for emergency services in an event of emergency. The process of providing access involves an authorized individual gaining access to the contents of the lockbox by retrieving one or more credentials stored within the lockbox and subsequently gain access within the premises or building space using the one or more credentials. However, there is no mechanism to determine if the credential is present within the lockbox without opening it. As the credentials are strictly managed, there is no way to determine if the credential is present or missing until emergency services personnel arrive and attempt to gain access to the contents of the lockbox.

There is therefore a need to provide a lockbox with external credential detection.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One aspect of the present disclosure includes a lockbox that houses one or more credentials. The lockbox comprises a retainer, a sensing element, and a processing circuit. The sensing element is associated with the retainer and is configured to detect one or more parameters of the retainer. In an aspect, the one or more parameters may include weight, angle, position, proximity, and visual recognition of the retainer. The sensing element is configured to detect the one or more parameters of the retainer to generate a sensed data. The processing circuit is communicatively coupled to the sensing element and is configured to receive the sensed data. Further, the processing circuit is configured to generate one or more notification signals indicative of presence or absence of the credential in the retainer.

In some aspects of the present disclosure, the one or more parameters include weight, angle, position, proximity, and visual image of the retainer.

In some aspects, the processing circuit is configured to compare the sensed data, which may include one or more values, with a reference check data stored in memory to determine presence of the credential.

In an aspect, the lockbox includes one or more communication interfaces that facilitates communication with one or more external devices. In an aspect, the external device may be a notification device or an output device. In another exemplary aspect, the external device may be an input device. In one other non-limiting example, the external device may include a computing device with bi-directional communication capabilities.

In an aspect, the credential may be a physical item such as one of, but not limited to, key, fob, smart card, and electronic tag.

In one other aspect of the present disclosure, a method to detect a presence of one or more credentials within a lockbox is envisaged. The method comprises receiving, by a processing circuit housed within a lockbox, a sensed value from a sensing element. In an aspect, the sensing element is coupled to a retainer of the lockbox adapted to accommodate one or more credentials. Further, the method includes the step of analyzing the sensed value by utilizing reference check data stored in memory to determine presence or absence of the credential. Still further, the method comprises generating one or more notification signals that indicates whether the credential is present or absent.

Another aspect of the present disclosure relates to a system configured to detect presence of a credential within a lockbox. The system comprises one or more external devices communicatively coupled to the lockbox to transmit a status signal. The system further comprises a processing circuit configured to cooperate with (e.g., by communicating with) a sensing element to receive a sensed data. Further, the processing circuit is configured to analyze the sensed data to determine presence or absence of the credential and/or generate one or more notification signals indicative of presence or absence of the credential. The system further comprises a communication interface configured to transmit the notification signal to the external device.

Yet another aspect of the present disclosure relates to a system to detect presence of a credential within a lockbox. The system comprises one or more external devices configured to transmit and/or receive wireless communication signals to detect presence or absence of a credential within the lockbox.

In an aspect, the credential is equipped with one or more wireless communication technologies to facilitate wireless communication with the one or more external devices.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a perspective view schematic drawing of a building with a security system, in accordance with various aspects of the present disclosure;

FIG. 2 is a block diagram of building security systems for multiple buildings communicating with a cloud-based security system, in accordance with various aspects of the present disclosure;

FIG. 3 is a block diagram illustrating several components of an access control system (ACS) that can be implemented in the building security systems of FIG. 2, in accordance with various aspects of the present disclosure;

FIG. 4 a schematic view of a lockbox, in accordance with various aspects of the present disclosure;

FIG. 5 is a block diagram illustrating components of the lockbox of FIG. 4, in accordance with various aspects of the present disclosure; and

FIG. 6 illustrates a flow chart depicting a method to determine presence or absence of a credential within a lockbox, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Organizations frequently secure keys, cards, and similar credentials in locked containers (also referred to as a lockbox), yet existing containers cannot confirm—between scheduled inspections—whether those items remain inside. Manual checks leave long intervals during which a credential may be removed, misplaced, or substituted without notice, impairing emergency readiness, delaying routine access, and obscuring accountability across both single-site and distributed facilities. The lack of standardized, machine-readable status information further prevents automated correlation of credential availability with building events, so system operators cannot easily prioritize alarms or deploy personnel efficiently.

To address one or more of these issues, the present disclosure includes a container that determines, without being opened, whether each stored credential is present and then reports that status to external devices so that readiness can be verified in real time from virtually any location. A housing defines at least one interior region closed by a movable barrier; the barrier can be secured by an input module that supports keyed, biometric, wireless, wired, or mechanical unlocking modes, allowing continued access if any single mode should become unavailable.

Within the housing, the present disclosure includes at least one retainer that positions the credential in a predictable relationship with one or more sensing elements. The retainer may take the form of a hook, cradle, bracket, magnetic seat, interference fit, optical shelf, or similar structure, establishing consistent placement while permitting quick removal by authorized users. The sensing elements generate data that change when the credential is added, removed, or disturbed; usable parameters include mass, displacement, tilt, strain, vibration, optical reflectance, electrical coupling, inductance, magnetic flux, acoustic response, thermal profile, radio-frequency behavior, or any combination thereof. Selecting or combining modalities enables reliable detection under varied environmental conditions.

A processing circuit receives the sensed data, references calibration values or historical baselines, and classifies each credential as present, absent, or indeterminate. The processing circuit may reside entirely within the housing, operate cooperatively with remote servers, or be partitioned across both, and can employ rule-based logic, statistical analysis, or machine-learning models to accommodate device drift and evolving usage patterns.

After classification, the present disclosure includes generation of a notification signal, conveyed through a communication interface that supports Ethernet, serial links, PoE, Wi-Fi, Bluetooth, NFC, ultra-wideband, cellular, LoRa, optical fiber, powerline, or other media, enabling seamless integration with legacy panels, building-management networks, cloud platforms, or mobile devices. Credentials equipped with active or passive transponders can also be interrogated directly through the same interface, allowing a sealed or compact enclosure while still supporting cryptographic challenge-response checks where heightened assurance is required. For example, the notification signal can be transmitted to external devices, such as mobile phones, computing systems, or building management systems.

This approach introduces significant advancements over previous systems by removing the requirement to physically open the lockbox to confirm the presence of credentials. The incorporation of sensing technologies and real-time communication capabilities allows authorized personnel to be promptly notified of the lockbox's status, improving operational efficiency and minimizing response times in urgent scenarios. Additionally, the system's ability to accommodate various sensing parameters and communication protocols enhances its flexibility and scalability for diverse applications, ranging from residential security to extensive commercial or industrial settings. By resolving the limitations of traditional lockboxes, the present system offers a dependable and effective method for credential management and security.

### Building Security System

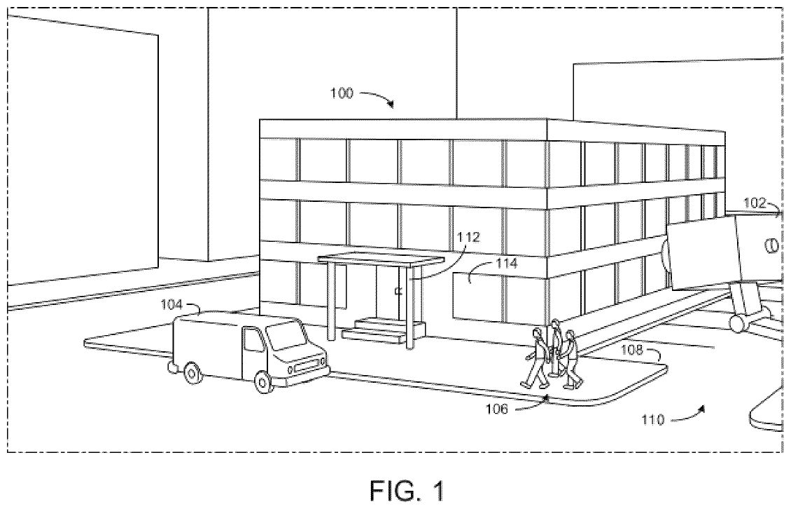

Referring now to FIG. 1, a building 100 with external surveillance such as a security camera 102 and a parking lot 110 is shown, according to an aspect. The building 100 shown is a multi-story commercial building surrounded by, or near, the parking lot 110, but can be any type of building in various aspects, such as a shed, residential home, garage, commercial building, industrial building, special purpose building, or other building or structure. As further examples, the building 100 may be a school, a hospital, a store, a place of business, a residence, a hotel, an office building, an apartment complex, etc. The building 100 can be public or private. The building 100 can be associated with the parking lot 110.

In the aspect shown, both the building 100 and the parking lot 110 are at least partially in the field of view of the security camera 102. In some aspects, multiple security cameras 102 may be configured to capture views of the exterior of the entire building 100 and/or parking lot 110 not in (or in to create multiple angles of overlapping or the same field of view) the field of view of a single security camera 102. The parking lot 110 can be used by one or more vehicles 104 where the vehicles 104 can be either stationary or moving (e.g. busses, cars, trucks, delivery vehicles, motorcycles, scooters, bicycles, hovercraft, drones, autonomous vehicles, and/or other manned and/or unmanned vehicles). The building 100 and parking lot 110 can be further used by one or more pedestrians 106 and/or pets who can traverse the parking lot 110 and/or enter and/or exit the building 100. The building 100 may be further surrounded, or partially surrounded, by a sidewalk 108 to facilitate the foot traffic of one or more pedestrians 106, facilitate deliveries, etc. In other aspects, the building 100 may be one of many buildings belonging to a single industrial park, shopping mall, or commercial park having a common parking lot and security camera 102. In another aspect, the building 100 may be a residential building or multiple residential buildings that share a common roadway and/or parking lot.

The building 100 is shown to include a door 112 and multiple windows 114. An access control system can be implemented within or otherwise associated with the building 100 to secure these potential entrance or egress ways of the building 100. For example, one or more badge readers can be positioned outside and/or within general proximity to the door 112 and can be configured to restrict access to the building 100. The pedestrians 106 can each be associated with one or more access badges that they can utilize with the access control system to gain access to the building 100 through the door 112. Furthermore, other interior doors within the building 100 can include and/or be associated with one or more access readers. In some aspects, the exterior and/or interior doors are secured via one or more security systems using biometric information, e.g., facial recognition, iris recognition, fingerprint scanners, voice recognition, or other biometric information. The access control system can generate and/or record events, e.g., an indication that a particular user or particular badge has interacted with a particular door. Furthermore, if one or more doors such as the door 112 is forced open, broken, or otherwise tampered with, the access control system, via door sensor, can detect the event and record, for example, a door forced open (DFO) event.

The windows 114 can be secured and/or monitored by the access control system via one or more burglar alarm sensors. These sensors can be configured to measure vibrations associated with the window 114. If vibration patterns or levels of vibrations are sensed by the sensors of the window 114, a burglar alarm can be generated by the access control system for the window 114. Alternatively or additionally, these sensors can be configured to sense a state of a window 114, such as open or closed, for a window 114 that is configured to be opened and closed by a user.

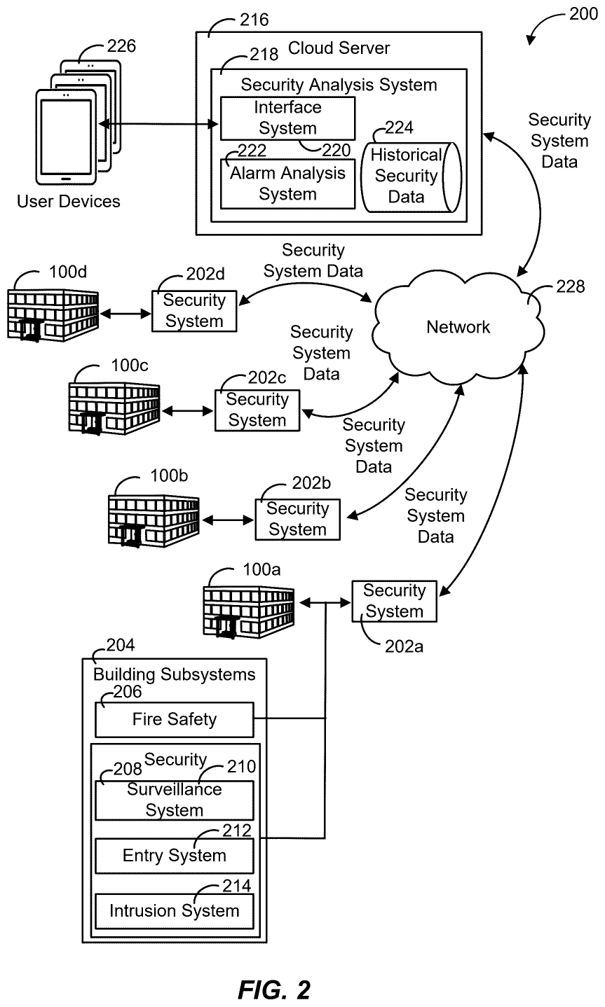

Referring now to FIG. 2, a security system 200 is shown for multiple buildings, according to an exemplary aspect. The security system 200 is shown to include buildings 100a-100d. Each of buildings 100a-100d is shown to be associated with a security system 202a-202d (e.g., a subsystem or individualized system for a particular building). The buildings 100a-100d may be the same as and/or similar to building 100 as described with reference to FIG. 1. The security systems 202a-202d may be one or more controllers, servers, and/or computers located in a security panel or part of a central computing system for a building.

The security systems 202a-202d may communicate with, or include, various security sensors and/or actuators, building subsystems 204. For example, subsystems and/or sensors can include fire safety subsystems 206, which may include one or more of various smoke sensors and alarm devices, carbon monoxide sensors, alarm devices, or other fire safety subsystem components and/or devices. Security subsystems 208 are shown in the example aspect to include a surveillance system 210, an entry system 212, and an intrusion system 214. The surveillance system 210 may include various video cameras, still image cameras, and image and/or video processing systems for monitoring various rooms, hallways, parking lots, the exterior of a building, the roof of the building, or other locations of the associated building. The entry system 212 can include one or more systems configured to allow users to enter and exit the building (e.g., door sensors, turnstiles, gated entries, badge systems, or other access systems.) The intrusion system 214 may include one or more sensors configured to identify whether an intrusion has occurred, such as if a window or door has been forced open. The intrusion system 214 can include one or more keypad modules for arming and/or disarming a security system and various motion sensors (e.g., infrared (IR), passive IR (PIR), acoustic sensors, or other motion sensors) configured to detect motion in various zones of the building 100a.

Each of buildings 100a-100d may be located in various locations such as towns, cities, states, and/or countries across the world. There may be any number of buildings 100a-100d that can be associated by a particular organization, such as a company, association, government, military, or other organization. The buildings 100a-100d may be owned and operated by one or more entities. For example, a grocery store entity may own and operate buildings 100a-100d in a particular geographic state. The security systems 202a-202d may record data from one or more of the building subsystems 204 and communicate collected security system data to the cloud server 216 via network 228, where it may be stored, accessed, or otherwise used.

In some aspects, the network 228 communicatively couples the devices, systems, and servers of the system 200. In some aspects, the network 228 is at least one of and/or a combination of a wired and/or wireless network, such as a Wi-Fi network, a wired Ethernet network, a ZigBee network, a Bluetooth network, and/or any other wired and/or wireless network. The network 228 may be a local area network and/or a wide area network (e.g., the Internet, a building WAN, etc.) and may use a variety of communications protocols (e.g., BACnet, IP, LON, etc.). The network 228 may include routers, modems, and/or network switches. The network 228 may be a combination of wired and wireless networks.

The cloud server 216 is shown in the example aspect to include a security analysis system 218 that receives security system data from the security systems 202a-202d of the buildings 100a-100d. The cloud server 216 may include one or more processing circuits (e.g., memory devices, processors, databases, and/or other circuits and/or components) configured to perform the various functionalities described herein. The cloud server 216 may be a private server and/or hosted on a private server. In some aspects, the cloud server 216 is implemented by a cloud system, examples of which include AMAZON WEB SERVICES® (AWS) and MICROSOFT AZURE®.

A processing circuit of the cloud server 216 can include one or more processors and memory devices. The one or more processors can be a general purpose or specific purpose processor, an application specific integrated circuit (ASIC), one or more field programmable gate arrays (FPGAs), a group of processing components, or other suitable processing components. The processor may be configured to execute computer code and/or instructions stored in a memory or received from other computer readable media (e.g., CD ROM, network storage, a remote server, or other computer readable media).

The memory can be non-transitory and include one or more devices (e.g., memory units, memory devices, storage devices, and/or other devices) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuit and can include computer code for executing (e.g., by the processor) one or more processes described herein.

In some aspects, the cloud server 216 can be wholly or partially located on premises within one of the buildings 100a-100d. For example, a user may wish that their security, fire, or HVAC data remain confidential and have a lower risk of being compromised. In such an instance, the cloud server 216 may be located on-premises instead of within or at an off-premises cloud platform. The security analysis system 218 may implement an interface system 220, an alarm analysis system 222, and a database storing historical security data 224, security system data collected from the security systems 202a-202d. The interface system 220 may provide various interfaces of user devices 226 for monitoring and/or controlling the security systems 202a-202d of the buildings 100a-100d. The interfaces may include various maps, alarm information, maintenance ordering systems, and/or other interfaces. The historical security data 224 can be aggregated security alarm and/or event data collected via the network 228 from the buildings 100a-100d. The alarm analysis system 222 can be configured to analyze the aggregated data to identify insights, detect alarms, reduce false alarms, and/or other desirable or useful information. Analysis can be performed according to instructions stored in memory and executed by one or more processors. For example, one or more algorithms, artificial intelligence (AI) and/or machine learning (ML) can be used to analyze data and/or otherwise glean information. The analysis results of the alarm analysis system 222 can be provided to a user via the interface system 220. In some aspects, the results of the analysis performed by the alarm analysis system 222 are provided as inputs such as one or more control actions to the security systems 202a-202d via the network 228.

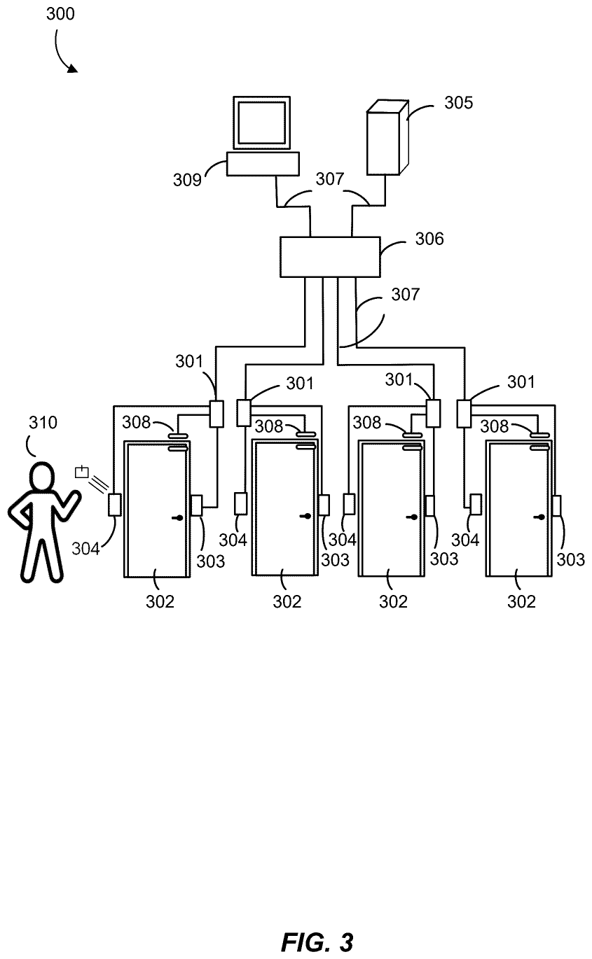

Referring now to FIG. 3, a block diagram of an ACS 300 is shown, according to an aspect. The ACS 300 can be implemented in any of the buildings 100a-100d, for example as described with reference to FIG. 2. In the example aspect shown, the ACS 300 is shown to include a plurality of doors 302. Each of the doors 302 is associated with a door lock 303, an access reader module 304, and one or more door sensors 308. The door locks 303, the access reader modules 304, and the door sensors 308 may be connected to access controllers 301. The access controllers 301 may be connected to a network switch 306 that directs signals, according to the configuration of the ACS 300, through network connections 307 (e.g., physical wires and/or wireless communications links) interconnecting the access controllers 301 to an ACS server 305 (e.g., the cloud server 216). The ACS server 305 may be connected to an end-user terminal or interface 309 through network switch 306 and the network connections 307.

The ACS 300 can be configured to grant or deny access to a controlled or secured area. For example, a person 310 may approach the access reader module 304 and present credentials, such as an access card. The access reader module 304 may read the access card to identify a card ID, user ID, or other identifying information associated with the access card. The card ID, user ID, or other identifying information may be sent from the access reader module 304 to the access controller 301. The access controller 301 can compare the card ID, user ID, or other identifying information with information stored in one or more memories such as a database to determine whether to unlock the door lock 303 or open the door 302 based on whether the person 310 associated with the card ID, user ID, or other identifying information has permission to access the controlled or secured area.

### Lockbox with External Credential Detection

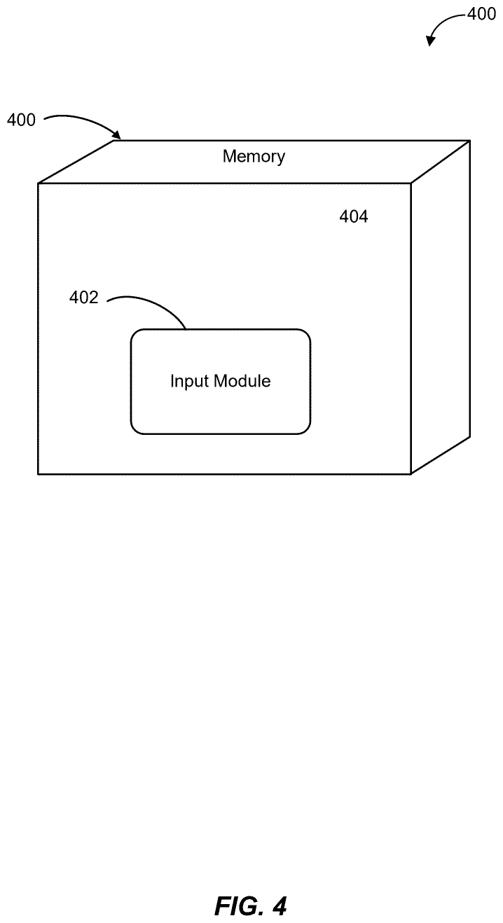

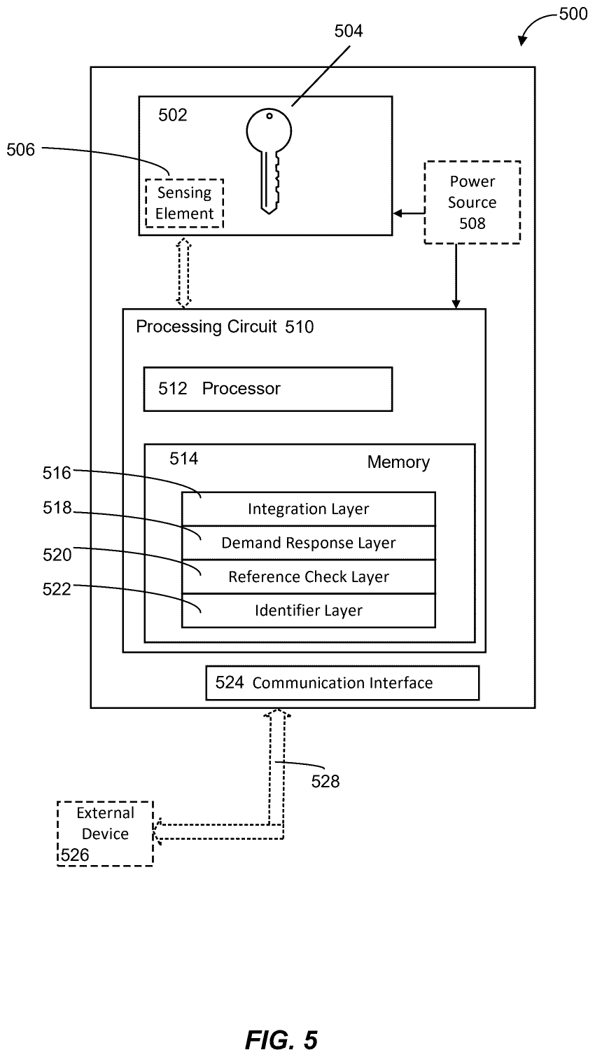

FIG. 4 illustrates a schematic view of a lockbox 400 according to some aspects of the present disclosure. The lockbox 400 is also referred to as a high security vault. The lockbox 400 is typically used to house or store one or more credentials 504 (shown in FIG. 5) therewithin, such as a physical item with data stored therein or otherwise. In an emergency event, the emergency service providers (e.g., one or more personnel) are equipped to gain access to one or more storage spaces of or within the lockbox 400 via an input module 402, thereby facilitating retrieval of the one or more credentials 504 from the lockbox 400. The one or more credentials 504 may be selected from, but not limited to a key, fob, smart card, electronic tag, or other credential.

In some aspects, the lockbox 400 includes a frame that defines a partially enclosed space, a front panel 404, and a rear panel (not shown in Figures). In an aspect, the frame defines an opening and the front panel 404 may be mounted to the frame (e.g., by one or more hinges) so as to be movable between an open position, whereby access to the interior storage space of the lockbox 400 can be obtained, and a closed position whereby access to the interior storage space of the lockbox 400 can be restricted. Further, the rear panel is fixedly attached to the frame thereby permitting access to the interior storage space of the lockbox via the front panel 404.

Further, in some aspects the input module 402 is part of the lockbox's 400 locking mechanism and is secured to the front panel 404 of the lockbox 400. The locking mechanism can secure a door to the frame in the closed position and can include one or more slidable or rotatable bolt, clasp, or other locking mechanism. In some aspects, the input module 402 may facilitate opening of the front panel 404 via keyless unlocking techniques such as selected from the group consisting of, but not limited to, Radio Frequency communication technique, Near Field Communication technique, facial recognition, iris scanner, biometric sensing, voice recognition, and One Time Passcode (OTP). In some other aspects, the input module 402 may include a lock that facilitates unlocking of the front panel 404 via a key.

The schematic representation of the lockbox 400 as depicted in FIG. 4 is for reference and does not limit the design configuration of the lockbox 400. That is, the design configuration of the lockbox 400 can be as per the space requirement and constraints. The size and depth of the lockbox 400 can be based on application requirement such as physical dimensions in a specific location and/or to house specific credential(s). Lockbox 400 can be a small vault to house a single credential or, alternatively, it can be of a suitable size to house multiple credentials.

In some exemplary aspects, the input module 402 may include or be otherwise coupled with a communication module that facilitates communication with a mobile device for locking and unlocking of the front panel 404. For example, the communication module can be configured to communicate via one or more wireless protocols with the mobile device. In some aspects a user can interact with the mobile device during a locking and/or unlocking operation, such as for verification. In some aspects, no user interaction is necessary.

In some aspects, the front panel 404 may be transparent or translucent to facilitate convenient inspection of credential 504 within the lockbox 400. For example, this can save time during an emergency situation where a quick visual inspection may allow emergency personnel to visual identify that a credential is housed within the lockbox 400 or is absent. In some other aspects, the front panel 404 may be a non-transparent panel. For example, this can discourage or otherwise prevent unauthorized individuals from identifying whether there is a credential housed in the lockbox 400.

Now referring to FIG. 5, the lockbox 400 is shown to include a retainer 502. In some aspects, the lockbox 400 can include one or more retainers 502 as per specific implementation needs and/or requirements. In an aspect, the retainer 502 may be one of, a hook, a holder, an anchor, a hollow body, a casing, a bracket, a wire, one or more rings (such as O-rings), a seal, a clip, a fastener, an infrared beam, a support member and the like. The retainer 502 facilitates placement of the credential 504 within the lockbox 400 and can retain a portion of the credential or.

In some aspects, the lockbox 400 further includes one or more sensing elements 506, at least one power source 508, a processing circuit 510, and a communication interface 524. In some aspects, the communication interface 524 may be part of the processing circuit 510. For example, communication interface 524 may include one or more wired or wireless interfaces (e.g., jacks, antennas, transmitters, receivers, transceivers, wire terminals, and other interfaces) for conducting data communications with various systems, devices, components and/or networks. Communication interface 524 can include an Ethernet card and port for sending and receiving data via an Ethernet-based communications network. In another example, communication interface 524 includes a Wi-Fi transceiver for communicating via a wireless communications network. Communication interface 524 may be configured to communicate via local area networks or wide area networks (e.g., the Internet, a building WAN, or other wide area networks).

In some aspects, communication interface 524 includes an application gateway configured to receive input from applications running on one or more external devices. For example, communication interface 524 may include one or more wireless transceivers (e.g., a Wi-Fi transceiver, a Bluetooth transceiver, a NFC transceiver, a cellular transceiver, or other transceiver) for communicating with external devices.

The sensing element 506 is associated with the retainer 502 and is configured to detect one or more parameters of the retainer 502 to generate a sensed data. In an aspect, the one or more parameters may be weight, angle, position, proximity, and visual image, or any combination thereof, of the retainer 502. One or more of the parameters of the retainer 502 may deviate from an expected, stored parameter when credential 504 is present within the lockbox 400.

For an example, the sensing element 506 may be a weight sensing element configured to detect weight of the retainer 502. A standard or expected weight may be set and a value stored in memory when the retainer 502 is not present or is empty. Then, when a credential 504 is placed in retainer 502 a weight value may be sensed by sensing element 506. This weight value may be stored with the standard or expected weight value and if there is a deviation or discrepancy, it may indicate the presence of a credential 504.

For instance, for weight detection the sensing element 506 may be realized as a miniature single-point load cell bonded beneath the retainer 502. When a credential rests on the retainer, the added mass slightly deflects a metal beam within the load cell, altering resistance in bonded strain gauges. A bridge circuit converts this resistance change into a millivolt signal that an on-board analog-to-digital converter forwards to the processor 512, which compares the measured value with an empty-retainer baseline to infer presence or removal.

To sense angle, in one non-limiting example implementation, the sensing element 506 can include a low-power three-axis MEMS accelerometer mounted on a hinged holder that pivots under spring bias. With the credential in place the holder hangs vertically and the accelerometer reports a stable gravity vector; after the credential is taken out the holder rises, rotating the accelerometer and shifting the reported vector, which the processor interprets as absence.

Position sensing can be achieved, in one non-limiting example implementation, by pairing a Hall-effect switch with a small permanent magnet embedded in the credential or in a sliding latch coupled to the retainer 502. When the magnet sits within a few millimeters of the Hall device, the switch output is high; once the magnet moves away the output drops, giving the processor a deterministic indication that the credential is no longer fully seated.

In another non-limiting example, for proximity detection, a self-contained capacitive proximity sensor may be mounted behind a non-conductive wall of the retainer. The sensor excites an electric field and monitors the resulting capacitance; introduction of a metal key or RFID card increases the dielectric constant, raising the sensor's analog output above a calibrated threshold so the processor can declare presence even without direct contact.

In a further non-limiting example implementation, the sensing element 506 may also be a compact camera positioned to view the retainer area. A light source, such as an infrared light emitting diode (LED), provides controlled illumination, allowing the camera to capture consistent frames regardless of ambient light. When prompted, the camera acquires an image, executes an image detection algorithm, such as edge-detection to isolate the credential outline, and compares the image or outline with a reference image or contour stored in memory 514. A close match confirms that the credential remains in place, whereas an absent or unexpected outline indicates removal or tampering.

In some aspects, the power source 508 may be configured to and responsible for supplying power to various electronic components of the lockbox 400. The electronic components of the lockbox 400 includes the sensing element 506, the processing circuit 510, and the communication interface 524.

The processing circuit 510 is communicatively coupled to the sensing element 506 and the communication interface 524. The processing circuit 510 receives the sensed data from the sensing element 506. The processing circuit 510, in some aspects, includes a processor 512 and a memory 514. The processor 512 can be a general purpose or specific purpose processor, an application specific integrated circuit (ASIC), one or more field programmable gate arrays (FPGAs), a group of processing components, or other suitable processing components. The processor 512 may be configured to execute computer code and/or instructions stored in the memory 514 or received from other computer readable media (e.g., CD ROM, network storage, a remote server, etc.).

The memory 514 can include one or more devices (e.g., memory units, memory devices, storage devices, or other memory devices) configured for storing data and/or computer code for completing and/or facilitating the various processes described in the present disclosure. The memory 514 can include random access memory (RAM), read-only memory (ROM), hard drive storage, temporary storage, non-volatile memory, flash memory, optical memory, or any other suitable memory for storing software objects and/or computer instructions. The memory 514 can include database components, object code components, script components, or any other type of information structure for supporting the various activities and information structures described in the present disclosure. The memory 514 can be communicably connected to the processor 512 via the processing circuit 510 and can include computer code for executing (e.g., by the processor 512) one or more processes described herein.

The memory 514 is shown to include one or more layers, such as an integration layer 516, a demand response layer 518, a reference check layer 520, and an identifier layer 522.

The integration layer 516 receives a status signal from one or more external devices 526 via the communication interface 524. The external devices 526 may be communicatively coupled with the lockbox 400 via a suitable communication link 528. In an aspect, the external device 526 may be one of, but not limited to, a remote computing device, a mobile computing device, a portable electronic device, a non-portable electronic device, a server, or a building management system, a security system, a building sub-system 206. The integration layer 516 is configured to interpret the status signal received from the external device 526 and convert it into a suitable signal for the demand respond layer 518 to digest. The demand response layer 518 subsequent to generation of the suitable signal generates a status check signal. The status check signal is communicated to the sensing element 506 subsequent to which the sensing element 506 generates the sensed data.

Further, the reference check layer 520 is configured to receive the sensed data from the sensing element 506 via the communication interface 524. The reference check layer 520 in one exemplary aspect compares the sensed data with a reference data. Furthermore, the reference check layer 520 generates deviation data based on the comparison which is then fed to the identifier layer 522.

Still referring to FIG. 5, the identifier layer 522 is configured to cooperate with the reference check layer 520 and receive the deviation data. The identifier layer 522 evaluates the deviation data and determines the presence or absence of the credential 504 associated with the retainer 502. Further, the identifier layer 522 generates a notification signal that indicates presence or absence of the credential 504. The notification signal generated by the identifier layer 522 is transmitted to the external device 526 via the communication interface 524.

In some aspects, the notification signal may be in form of text, graphics, audio, video, buzzers, color-coded notifiers, alarms or any combination thereof. For example, a notification icon may be provided on a user interface of the external device 526 to display the notification signal from the lockbox 400. In other aspects, the notification icon may be accompanied or replaced by audible alerts or indicators, flashing lights, or any other suitable means of notification.

In some aspects, the credential 504 may be present directly inside the lockbox 400 without any retainer 502. In such case, the credential 504 may be equipped with suitable wireless communication technologies such Bluetooth, NFC, Radio Frequency etc., to facilitate communication with the external device 526 upon transmission of wireless communication signals from the external device 526. Thus, presence of the credential 504 within the lockbox 400 is indicated upon successful communication of the external device 526 with the credential 504. However, one or more unsuccessful or failed communication attempts indicates absence of the credential 504 within the lockbox 400.

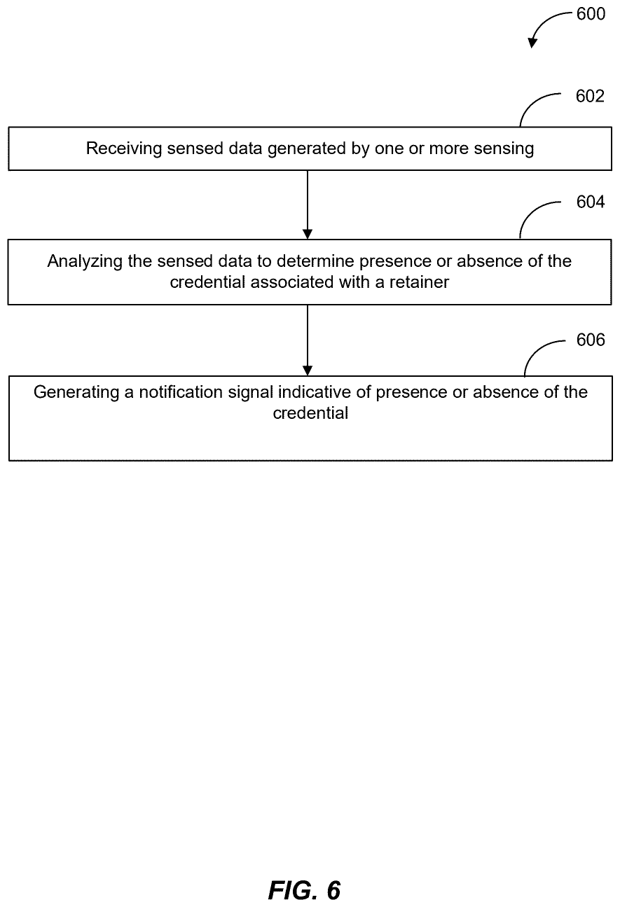

Referring now to FIG. 6, a flow chart of a method 600 for detecting presence of a credential within a lockbox is shown, according to some aspects.

In some aspects, the method 600 is performed by the lockbox 400 (referred above in FIGS. 4-5). Alternatively, the method 600 may be partially or completely performed by another computing system or controller of the building environment. The method 600 is shown to include receiving a sensed data generated by one or more sensing elements 506 (referred above in FIG. 5) (Block 602). In some aspects, one or more parameters of the retainer 502 (referred to above in FIG. 5) are detected to generate the sensed data. In an aspect, the one or more parameters may be weight, angle, position, and visual image of the retainer 502. One or more of the parameters of the retainer 502 tends to deviate when credential 504 is present within the lockbox 400.

In some aspects, a status signal may be received and interpreted by the integration layer 516 (referred to above in FIG. 5) from one or more external devices 526 via the communication interface 524 (referred to above in FIG. 5). The status signal may be converted into a suitable signal. Subsequent to generation of the suitable signal, a status check signal may be generated by the demand respond layer 518 (referred above in FIG. 5). Further, the status check signal may be communicated to the sensing element 506 subsequent to which the sensed data may be generated by the sensing element 506. In some aspects, the sensed data generated by the sensing element 506 may be received by the reference check layer 520 (referred above in FIG. 5) via the communication interface 524.

The method 600 is further shown to include analyzing the sensed data to determine presence or absence of the credential 504 associated with the retainer 502 (Block 604). In some aspects, the sensed data may be compared with a reference data (e.g., one or more values) by the reference check layer 520 to generate deviation data. The deviation data may be evaluated by the identifier layer 522 (referred above in FIG. 5) to determine the presence or absence of the credential 504 associated with the retainer 502.

The method 600 is further shown to include generating one or more notification signals indicative of presence or absence of the credential 504 (Block 606). In some aspects, the notification signals may be generated by the identifier layer 522 and are further transmitted to the external device 526 via the communication interface 524.

In some aspects, the notification signals may be in form of text, graphics, audio, video, buzzers, color-coded notifiers (e.g., LED lights), alarms or any combination thereof that are displayed via a visual indicator or display, emitted via a speaker or other audio transceiver, or other indication mechanism and/or component). For example, a notification icon may be provided on a user interface of the external device 526 to display the notification signal from the lockbox 400. In other aspects, the notification icon may be accompanied or replaced by audible alerts or indicators, flashing lights, or any other suitable means of notification.

### Configuration of Example Aspects

The construction and arrangement of the systems and methods as shown in the various exemplary aspects are illustrative only. Although only a few aspects have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative aspects. Other substitutions, modifications, changes, and omissions can be made in the design, operating conditions and arrangement of the exemplary aspects without departing from the scope of the present disclosure.

The present disclosure contemplates methods, systems and program products on any machine-readable media for accomplishing various operations. The aspects of the present disclosure can be implemented using existing computer processors, or by a special purpose computer processor for an appropriate system, incorporated for this or another purpose, or by a hardwired system. Aspects within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

The present disclosure may be implemented according to one or any combination of the following clauses.

Clause 1. A lockbox comprising: a retainer; at least one sensing element to detect one or more parameters of the retainer, and generate a sensed data; and a processing circuit to generate a notification signal indicative of presence or absence of a credential based on the sensed data.

Clause 2. The lockbox of clause 1, wherein the one or more parameters include weight, angle, position, and visual image.

Clause 3. The lockbox of any previous clause, wherein the processing circuit is configured to compare the sensed data with a reference check data to determine presence or absence of the credential associated with the retainer.

Clause 4. The lockbox of any previous clause, further comprising: a communication interface to facilitate communication with one or more external devices, wherein the communication interface is configured to receive a status request configured to activate the at least one sensing element.

Clause 5. The lockbox of any previous clause, wherein the processing circuit is configured to transmit the notification signal via the communication interface to the one or more external devices.

Clause 6. The lockbox of any previous clause, wherein the credential is selected from a key, fob, smart card, and electronic tag.

Clause 7. The lockbox of any previous clause, wherein the at least one sensing element comprises a weight sensor arranged to detect a change in weight of the retainer.

Clause 8. The lockbox of any previous clause, wherein the at least one sensing element comprises a camera configured to obtain an image of an area associated with the retainer.

Clause 9. The lockbox of any previous clause, wherein the at least one sensing element comprises an accelerometer, a Hall-effect switch, or a capacitive proximity sensor.

Clause 10. The lockbox of any previous clause, wherein the processing circuit is configured to fuse outputs of two or more of the at least one sensing element to determine the presence or the absence of the credential.

Clause 11. A method comprising: receiving, by a processing circuit, a sensed data generated by one or more sensing elements, wherein the sensed data pertains to one or more parameters of a retainer that holds the credential; analyzing, by the processing circuit, the sensed data to determine presence or absence of a credential associated with the retainer; and generating, by the processing circuit, a notification signal indicative of presence or absence of the credential with respect to the retainer.

Clause 12. The method of clause 11, further comprising comparing the sensed data to reference data stored in a memory to determine the presence or the absence of the credential.

Clause 13. The method of clause 11, wherein the sensed data are generated by a weight sensor detecting a change in weight of the retainer.

Clause 14. The method of any previous clause, wherein the sensed data are generated by a camera directed toward the retainer.

Clause 15. The method of any previous clause, further comprising unlocking a movable barrier of a housing within which the retainer is mounted in response to receipt of an access signal generated by an input module.

Clause 16. The method of any previous clause, wherein the access signal is generated in response to at least one of a mechanical key input, a biometric input, or a radio-frequency credential.

Clause 18. The method of any previous clause, wherein transmitting the signal comprises wirelessly transmitting a data packet over an Internet Protocol network to a building management system.

Clause 19. The method of any previous clause, further comprising activating the at least one sensing element in response to a status request received through the communication interface.

Clause 20. A system to detect presence of a credential within a lockbox, the system comprising: one or more external devices communicatively coupled to the lockbox, wherein the one or more of the external devices transmits a status signal; a processing circuit configured to: cooperate with a sensing element to receive a sensed data; analyze the sensed data to determine presence or absence of the credential; and generate a notification signal indicative of presence or absence of the credential; and a communication interface configured to transmit the notification signal to the external device.

Clause 21. A system to detect presence of a credential within a lockbox, the system comprising: one or more external devices configured to transmit wireless communication signals to detect presence or absence of the credential within the lockbox.

Clause 22. The system of clause 21, wherein the credential is equipped with one or more wireless communication technologies to facilitate wireless communication with the one or more external devices.

Aspects of this disclosure are described herein with reference to block diagrams and flowchart illustrations of processor-implemented methods, systems, devices, apparatuses, and computer program products. It can be understood that each block of the block diagrams and flowchart illustrations, and combinations of blocks in the block diagrams and flowchart illustrations, respectively, can be implemented by processor-accessible instructions. Such instructions may include, for example, computer program instructions (e.g., processor-readable and/or processor-executable instructions). The processor-accessible instructions may be built (e.g., linked and compiled) and retained in processor-executable form in one or multiple memory devices or one or many other processor-accessible non-transitory storage media. These computer program instructions also can be stored in a processor-readable memory, where in response to execution by one or more processors, individually or in combination, the computer program instructions can direct a computer, a computing device, or other programmable data processing apparatus to function in a particular manner, such that the instructions stored in the processor-readable memory produce an article of manufacture including processor-accessible instructions (e.g., processor-readable instructions and/or processor executable instructions) to implement the function specified in the flowchart blocks (individually or in a particular combination) or blocks in block diagrams (individually or in a particular combination). The computer program instructions can be loaded onto a computer, a computing device, or other programmable data processing apparatus to cause a series of operations to be performed on the computer or other programmable apparatus to produce a computer-implemented process. The series of operations may be performed in response to execution by one or more processor or other types of processing circuitry. Thus, such instructions that execute on the computer or other programmable apparatus provide operations for implementing the functions specified in the flowchart blocks (individually or in a particular combination) or blocks in block diagrams (individually or in a particular combination).

In some implementations, the processor-accessible instructions may be loaded or otherwise incorporated into a general purpose computer, a special purpose computer, or another programmable information processing apparatus to produce a particular machine, such that the operations or functions specified in flowchart blocks or other blocks presented in this disclosure can be implemented in response to execution at the computer or processing apparatus. More specifically, the loaded processor-accessible instructions may be accessed and executed by one or multiple processors, individually or in combination, or other types of processing circuitry. In response to execution, the loaded processor-accessible instructions provide the functionality described in connection with flowchart blocks (individually or in a particular combination) or blocks in block diagrams (individually or in a particular combination). Thus, such instructions which execute on a computer, a computing device, or other programmable data processing apparatus can create a means for implementing the functions specified in the flowchart blocks (individually or in a particular combination) or blocks in block diagrams (individually or in a particular combination).

As used in this disclosure, including the annexed drawings, in some aspects the terms “component,” “module,” “interface,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

Unless otherwise expressly stated, it is in no way intended that any protocol, procedure, process, functionality or combination of functionalities, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that he steps are to be limited to a specific order, it is in no way intended that an order be inferred, in any respect. This holds for any possible non-express basis for interpretation, including; matters of logic with respect to the arrangement of steps or operational flow; plain meaning derived from grammatical organization or punctuation; the number or type of aspects described in the specification or annexed drawings; or the like.

As used in this disclosure, including the annexed drawings, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, refers to any computing processing unit or device comprising processing circuitry that can operate on data and/or signaling. A computing processing unit or device may include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor may include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, system, device, apparatus, or article of manufacture using standard programming and/or engineering techniques. In addition, various of the aspects disclosed herein also can be implemented by means of program modules or other types of computer program instructions stored in memory device and executed by a processor, or other combination of hardware and software, or hardware and firmware. Such program modules or computer program instructions can be loaded onto a general purpose computer, a special purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A lockbox, comprising:
a retainer;
at least one sensing element to detect one or more parameters of the retainer, and generate a sensed data; and
a processing circuit to generate a notification signal indicative of presence or absence of a credential based on the sensed data.

2. The lockbox of claim 1, wherein the one or more parameters include weight, angle, position, and visual image.

3. The lockbox of claim 1, wherein the processing circuit is configured to compare the sensed data with a reference check data to determine presence or absence of the credential associated with the retainer.

4. The lockbox of claim 1, further comprising:
a communication interface to facilitate communication with one or more external devices, wherein the communication interface is configured to receive a status request configured to activate the at least one sensing element.

5. The lockbox of claim 4, wherein the processing circuit is configured to transmit the notification signal via the communication interface to the one or more external devices.

6. The lockbox of claim 1, wherein the credential is selected from a key, fob, smart card, and electronic tag.

7. The lockbox of claim 1, wherein the at least one sensing element comprises a weight sensor arranged to detect a change in weight of the retainer.

8. The lockbox of claim 1, wherein the at least one sensing element comprises a camera configured to obtain an image of an area associated with the retainer.

9. The lockbox of claim 1, wherein the at least one sensing element comprises an accelerometer, a Hall-effect switch, or a capacitive proximity sensor.

10. The lockbox of claim 1, wherein the processing circuit is configured to fuse outputs of two or more of the at least one sensing element to determine the presence or the absence of the credential.

11. A method, comprising:
receiving, by a processing circuit, a sensed data generated by one or more sensing elements, wherein the sensed data pertains to one or more parameters of a retainer that holds the credential;
analyzing, by the processing circuit, the sensed data to determine presence or absence of a credential associated with the retainer; and
generating, by the processing circuit, a notification signal indicative of presence or absence of the credential with respect to the retainer.

12. The method of claim 11, further comprising comparing the sensed data to reference data stored in a memory to determine the presence or the absence of the credential.

13. The method of claim 11, wherein the sensed data are generated by a weight sensor detecting a change in weight of the retainer.

14. The method of claim 11, wherein the sensed data are generated by a camera directed toward the retainer.

15. The method of claim 11, further comprising unlocking a movable barrier of a housing within which the retainer is mounted in response to receipt of an access signal generated by an input module.

16. The method of claim 15, wherein the access signal is generated in response to at least one of a mechanical key input, a biometric input, or a radio-frequency credential.

18. The method of claim 11, wherein transmitting the signal comprises wirelessly transmitting a data packet over an Internet Protocol network to a building management system.

19. The method of claim 11, further comprising activating the at least one sensing element in response to a status request received through the communication interface.

20. A system to detect presence of a credential within a lockbox, comprising:
one or more external devices communicatively coupled to the lockbox, wherein the one or more of the external devices transmits a status signal;
a processing circuit configured to:
cooperate with a sensing element to receive a sensed data;
analyze the sensed data to determine presence or absence of the credential; and
generate a notification signal indicative of presence or absence of the credential; and
a communication interface configured to transmit the notification signal to the external device.

21. A system to detect presence of a credential within a lockbox, comprising:
one or more external devices configured to transmit wireless communication signals to detect presence or absence of the credential within the lockbox.

22. The system of claim 21, wherein the credential is equipped with one or more wireless communication technologies to facilitate wireless communication with the one or more external devices.
